(19) United States
(12) Patent Application Publication
(10) Pub. No.: US 2024/0050891 A1
(43) Pub. Date: Feb. 15, 2024

(54) SYSTEM AND METHOD FOR REMOVING CARBON DIOXIDE FROM A FLOW OF GAS HAVING CARBON DIOXIDE THEREIN

(71) Applicant: Emerging Compounds Treatment Technologies, Inc., North Little Rock, AR (US)

(72) Inventors: Peter Zemek, Hollis, NH (US); Steven E. Woodard, Cumberland, ME (US); Michael G. Nickelsen, Fuquay-Varina, NC (US); David Kempisty, Colorado Springs, CO (US)

(21) Appl. No.: 18/365,634

(22) Filed: Aug. 4, 2023

Related U.S. Application Data
(60) Provisional application No. 63/490,789, filed on Mar. 17, 2023.
(60) Provisional application No. 63/486,273, filed on Feb. 22, 2023.
(60) Provisional application No. 63/397,019, filed on Aug. 11, 2022.

(51) Int. Cl. B01D 53/14; B01D 53/78; B01D 53/96

(52) U.S. Cl. CPC B01D 53/1475; B01D 53/78; B01D 53/96; B01D 2256/22; B01D 2257/504

(57) ABSTRACT

A system for removing carbon dioxide from flow of gas having carbon dioxide including a venturi eductor configured to receive the flow of gas having carbon dioxide therein and a flow of an alkaline solution at a predetermined pH range. The venturi eductor is configured to introduce and mix the flow of gas having carbon dioxide therein into the flow of the alkaline solution to induce the transfer of the carbon dioxide into a carbonic acid solution and the subsequent conversion of the carbonic acid solution into a solution having metal carbonate therein. A reactor is coupled to the venturi eductor includes a volume of the alkaline solution and is configured to provide sufficient reaction time to augment the transfer of carbon dioxide into the carbonic acid solution and the subsequent conversion of the carbonic acid solution into a solution having metal carbonate therein and output a flow of treated gas having a majority of the carbon dioxide removed. A pump coupled to the reactor is configured to recycle the flow of alkaline solution from the reactor to the venturi eductor such that the venturi eductor introduces and mixes the flow of gas with the flow of the alkaline solution. An output is coupled to the reactor and is configured to output a flow of a solution having metal carbonate therein to minimize the formation of metal carbonate precipitate in the reactor. A pH adjustment subsystem is configured to maintain the pH of alkaline solution at the predetermined pH range.

### RELATED APPLICATIONS

This application claims benefit of and priority to U.S. Provisional Application Ser. No. 63/490,789 filed Mar. 17, 2023, U.S. Provisional Application Ser. No. 63/486,273 filed Feb. 22, 2023, and U.S. Provisional Application Ser. No. 63/397,019 filed Aug. 11, 2022 under 35 U.S.C. §§ 119, 120, 363, 365, and 37 C.F.R. § 1.55 and § 1.78, all of which are incorporated herein by this reference.

### FIELD OF THE INVENTION

This invention relates to a system and method for removing carbon dioxide from a flow of gas having carbon dioxide therein.

### BACKGROUND OF THE INVENTION

A flow of gas having carbon dioxide therein may include any gas or vapor source having carbon dioxide therein. The gas or vapor source may include, inter alia, a fossil fuel combustion power plant, a boiler, a furnace, an incinerator, a steam generator, a petroleum refinery, a chemical or petrochemical facility, a gas processing facility, a cement plant, an iron or steel manufacturing facility, a brewery, a bakery, a glass manufacturing facility, or similar type facilities or devices, an exhaust gas stream generated by an internal combustion engine, or a flow of ambient air.

As is well known, carbon dioxide is a greenhouse gas that contributes to global warming/climate change.

Thus, there is a need for an efficient and effective system and method to remove carbon dioxide from a flow of gas having carbon dioxide therein.

### SUMMARY OF THE INVENTION

In one aspect, a system for removing carbon dioxide from flow of gas having carbon dioxide therein is featured. The system includes a venturi eductor configured to receive the flow of gas having carbon dioxide therein and a flow of an alkaline solution at a predetermined pH range. The venturi eductor is configured to introduce and mix the flow of gas having carbon dioxide therein into the flow of the alkaline solution to induce the transfer of the carbon dioxide into a carbonic acid solution and the subsequent conversion of the carbonic acid solution into a solution having metal carbonate therein. A reactor is coupled to the venturi eductor. The reactor includes a volume of the alkaline solution and is configured to provide sufficient reaction time to augment the transfer of carbon dioxide into the carbonic acid solution and the subsequent conversion of the carbonic acid solution into a solution having metal carbonate therein and output a flow of treated gas having a majority of the carbon dioxide removed. At least one pump is coupled to the reactor and is configured to recycle the flow of alkaline solution from the reactor to the venturi eductor such that the venturi eductor introduces and mixes the flow of gas with the flow of the alkaline solution. An output is coupled to the reactor and is configured to output a flow of a solution having metal carbonate therein to minimize the formation of metal carbonate precipitate in the reactor. A pH adjustment subsystem is configured to maintain the pH of alkaline solution at the predetermined pH range.

In one example, at least one heat exchanger subsystem may be configured to cool the flow of gas having carbon dioxide therein. The predetermined pH range may range from about 10 to about 14. At least one pump may operate in cavitation to enhance the transfer of unreacted carbon dioxide into the carbonic acid solution. A heat exchanger subsystem coupled to the at least one pump may be configured to maintain a temperature of alkaline solution in the reactor at a temperature which induces the transfer of the carbon dioxide into the carbonic acid solution. The pH adjustment subsystem may be configured to introduce a flow of a concentrated alkaline solution into the flow of the alkaline solution and/or the reactor to maintain the pH at the predetermined pH range. A dilution subsystem may be configured to introduce a flow of water into the flow of the alkaline solution and/or the reactor to minimize precipitation of metal carbonate in the flow of the alkaline solution and/or in the reactor. The pH adjustment system may be configured to minimize formation of metal carbonate precipitate by adjusting the flow rate of the concentrated alkaline solution into the flow of the alkali solution and/or the flow rate of the flow of the concentrated alkaline solution into the reactor. A carbon dioxide monitoring subsystem may be configured to measure carbon dioxide concentration in the flow of treated gas having a majority of the carbon dioxide removed. One or more pH sensors may be configured to measure the pH of the flow of alkaline solution and/or the alkaline solution in the reactor. A control subsystem may be coupled to the carbon dioxide monitoring subsystem, the one or more pH sensors, and the pH adjustment subsystem. The control subsystem may be configured to adjust the flow rate of the concentrated alkaline solution to maintain the pH of the alkaline solution at the predetermined pH range based on the measured carbon dioxide concentration. A gas diffuser subsystem may be coupled to the reactor and/or the flow of the alkaline solution. The gas diffuser subsystem may be configured to generate fine bubbles, microbubbles, and/or nanobubbles to enhance the transfer of carbon dioxide into the carbonic acid solution. An evaporator subsystem may be coupled to the output may be configured to evaporate water from the flow of the solution having metal carbonate therein and output a metal carbonate slurry or a metal carbonate solid and water vapor. Waste heat may be input to the evaporator subsystem to promote the evaporation of water from the flow of solution having metal carbonate therein. Greater than about 95% of the carbon dioxide may be removed from the flow of gas having carbon dioxide therein. Greater than about 99% of the carbon dioxide may be removed from the flow of gas having carbon dioxide therein. The reactor may operate in batch mode.

In another aspect, a method for removing carbon dioxide from a flow of gas having carbon dioxide therein is featured. The method includes receiving the flow of gas having carbon dioxide therein and a flow of an alkaline solution at a predetermined pH range. The method also includes introducing and mixing the flow of gas having carbon dioxide therein into the flow of the alkaline solution to induce the transfer of the carbon dioxide into a carbonic acid solution and the subsequent conversion of the carbonic acid solution into a solution having metal carbonate therein, providing sufficient reaction time to augment the transfer of carbon dioxide into the carbonic acid solution and the subsequent conversion of the carbonic acid solution into a solution having metal carbonate therein. The method also includes outputting a flow of treated gas having a majority of the carbon dioxide removed, recycling the flow of alkaline solution to introduce and mix the flow of gas with the flow of the alkaline solution, outputting a flow of a solution having metal carbonate therein to minimize the formation of metal carbonate precipitate, and maintaining the pH of alkaline solution at the predetermined pH range.

In one example, the method may include cooling the flow of gas having carbon dioxide therein. The predetermined pH range may be in the range about 10 to about 14. The method may include operating at least one pump in cavitation to enhance the transfer of unreacted carbon dioxide into the carbonic acid solution. The method may include maintaining the temperature of alkaline solution at a temperature which induces the transfer of the carbon dioxide into the carbonic acid solution. The method may include introducing a flow of a concentrated alkaline solution into the flow of the alkaline solution to maintain the pH at the predetermined pH range. The method may include introducing a flow of water into the flow of the alkaline solution to minimize precipitation of metal carbonate in the flow of the alkaline solution and/or in the reactor. The method may include minimizing formation of metal carbonate precipitate by adjusting the flow rate of the concentrated alkaline solution into the flow of the alkali solution. The method may include measuring carbon dioxide concentration in the flow of treated gas having a majority of the carbon dioxide removed. The method may include measuring the pH of the flow of alkaline solution and/or the alkaline solution in the reactor. The method may include adjusting the flow rate of the concentrated alkaline solution to maintain the pH of the alkaline solution at the predetermined pH range based on the measured pH and the measured carbon dioxide concentration. The method may include generating fine bubbles, microbubbles, and/or nanobubbles to enhance the transfer of the carbon dioxide into the carbonic acid solution. The method may include evaporating water from the flow of the solution having metal carbonate therein and outputting a metal carbonate slurry or a metal carbonate solid therein and water vapor. Waste heat may be input to promote the evaporation of water from the flow of solution having metal carbonate therein. Greater than about 95% of the carbon dioxide may be removed from the flow of gas having carbon dioxide therein. Greater than about 99% of the carbon dioxide may be removed from the flow of gas having carbon dioxide therein. Providing sufficient reaction time may be performed in batch mode.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block diagram showing one example of the system for removing carbon dioxide from a flow of gas having carbon dioxide therein;

FIG. 2 is a schematic block diagram showing another example of the system for removing carbon dioxide from a flow of gas having carbon dioxide therein; and

FIG. 3 is a flow chart showing the primary steps of one example of method for removing carbon dioxide from a flow of gas having carbon dioxide therein.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

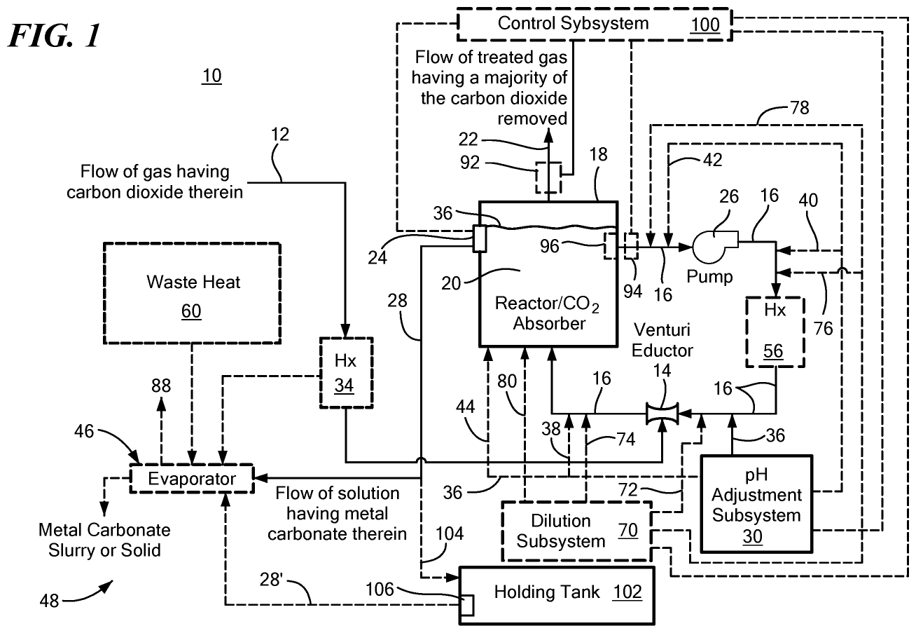

There is shown in FIG. 1, one example of system 10 for removing carbon dioxide from flow 12 of gas having carbon dioxide therein. Flow 12 of gas having carbon dioxide therein may include any gas or vapor source having carbon dioxide therein. The gas or vapor source may include, inter alia, a fossil fuel combustion power plant, a boiler, a furnace, an incinerator, a steam generator, a petroleum refinery, a chemical or petrochemical facility, a gas processing facility, a cement plant, an iron or steel manufacturing facility, a brewery, a bakery, a glass manufacturing facility, or similar type facilities or devices, an exhaust gas stream generated by an internal combustion engine, or a flow of ambient air

In some examples, flow 12 may be hot, e.g., about 700° F. to about 1000° F. or similar high temperature, and needs to be cooled, e.g., to about 70° F. to about 120° F., or similar lower temperature, prior to entering a CO₂ removal reactor, as discussed below. To address this, system 10 may include at least one heat exchanger subsystem 34 which receives flow 12 and cools it as needed.

System 10 includes venturi eductor 14 which receives flow 12 of gas having carbon dioxide therein and flow 16 of an alkaline solution at a predetermined pH range.

In one example, the predetermined pH range of the alkaline solution is preferably in the range of about 10 to about 14. The alkaline solution at the predetermined pH range preferably includes a liquid, such as water, deionized water, or similar type liquid and an alkali, such as sodium hydroxide, potassium hydroxide, magnesium hydroxide, or similar type alkali.

Venturi eductor 14 introduces and mixes flow 12 of gas having carbon dioxide therein into flow 16 of alkaline solution to induce the transfer of the carbon dioxide into a carbonic acid (H₂CO₃) solution and the subsequent conversion of the carbonic acid solution into a solution having metal carbonate therein. The solution having metal carbonate therein may include trace amounts of metal bicarbonate and/or other chemical constituents.

System 10 also includes reactor 18, also referred to herein as a carbon dioxide removal reactor or a carbon dioxide absorber, coupled to venturi eductor 14 as shown. Reactor 18 includes a volume of the alkaline solution at the predetermined pH range, indicated at 20. Reactor 18 with the alkaline solution therein provides sufficient reaction time to augment the transfer of the carbon dioxide into the carbonic acid solution and the subsequent conversion of the carbonic acid solution into the solution having metal carbonate therein. Reactor 18 outputs flow 22 of treated gas having a majority of the carbon dioxide removed. As disclosed herein, a majority is greater than about 50%. In one example, system 10 outputs flow 22 of treated gas having greater than about 95% of the carbon dioxide removed. In another example, system 10 outputs flow 22 of treated gas having greater than about 99% of the carbon dioxide removed.

As discussed above, reactor 18 having the alkaline solution at the predetermined pH range therein induces the conversion of carbon dioxide into the carbonic acid (H₂CO₃) solution and the subsequent conversion of the carbonic acid solution into the solution having metal carbonate therein. When the alkaline solution is at the predetermined pH range, the carbonic acid solution is converted to the solution having metal carbonate therein by the following reaction:

H₂CO₃→HCO₃⁻CO₃⁻² (1)

The carbonate ions react with the alkaline solution to form a solution of a metal carbonate, e.g., sodium carbonate (Na₂CO₃), potassium carbonate (K₂CO₃), magnesium carbonate (MgCO₃) or similar type metal carbonate.

System 10 also includes at least one pump 26 coupled to reactor 18 as shown. Pump 26 recycles the alkaline solution in reactor 18 having metal carbonate and any unreacted carbon dioxide therein from reactor 18 back to venturi eductor 14 as shown by flow 16. Flow 16 is pumped at a sufficient rate so that venturi eductor 14 can effectively introduce and mix flow 12 with flow 16 to induce the transfer of the carbon dioxide into the carbonic acid solution and the subsequent conversion of the carbonic acid solution into the solution having metal carbonate therein.

System 10 also includes output 24 coupled to reactor 18 which outputs flow 28 of solution having metal carbonate therein to minimize the formation of metal carbonate precipitate in reactor 18. In one example, the flow rate of flow 28 is preferably at a rate which is fast enough to prevent the alkaline solution in reactor 18 from becoming supersaturated with metal carbonate.

As is well known in the art, the formation of a metal carbonate precipitate in reactor 18 may significantly decrease the performance of reactor 18 by forming precipitate on the walls of reactor 18 and the various components of system 10 including, inter alia, venturi eductor 14 and/or pump 26.

System 10 also includes pH adjustment subsystem 30 which maintains the pH of the alkaline solution in flow 16 and/or reactor 18 at the predetermined pH range. In one example, pH adjustment subsystem 30 introduces flow 36 of a concentrated alkaline solution into flow 16 and/or reactor 20 to maintain the pH of flow 16 and the pH of the alkaline solution in reactor 18 at the predetermined pH range. Flow 36 of concentrated alkaline solution may include sodium hydroxide (NaOH), potassium hydroxide (KOH), magnesium hydroxide Mg(OH)₂, calcium hydroxide Ca(OH)₂, or similar type alkali. In one example, the concentration of flow 36 of concentrated alkaline solution is about 1% to about 50%.

In one design, flow 36 of concentrated alkaline solution may be introduced into flow 16 upstream from venturi eductor 14 as shown. In other examples, flow 36 may be introduced to flow 16 downstream from venturi eductor 14, indicated at 38, downstream or upstream from pump 26, indicated at 40, 42, respectfully, and/or directly to reactor 18, indicated at 44.

As is well known in the art, it is important to maintain the concentration of metal carbonate below its saturation concentration to prevent or minimize precipitation. In one example, output 24 coupled to reactor 18 outputs flow 28 of the solution having metal carbonate therein at a flow rate which prevents or minimizes the formation of metal carbonate precipitate in reactor 18.

In another example, system 10 preferably includes dilution subsystem 70 which preferably introduces flow 72 of water into flow 16 of the alkaline solution and/or reactor 18 as shown to minimize precipitation of metal carbonate in the flow 16 of alkaline solution and/or the alkaline solution in reactor 20.

In one design, flow 72 of water may be introduced into flow 16 upstream from venturi eductor 14 as shown. In other examples, flow 72 of may be introduced to flow 16 downstream from venturi eductor 14, indicated at 74, downstream or upstream from pump 26, indicated at 76, 78, respectfully, and/or directly to reactor 18, indicated at 80.

In one design, pH adjustment system 30 preferably minimizes formation of the metal carbonate precipitate by adjusting the flow rate of flow 36 of concentrated alkaline solution into flow 16 of the alkaline solution and/or reactor 18 as shown.

System 10 may also include carbon dioxide monitoring subsystem 92 which preferably measures carbon dioxide concentration of flow 22 of treated gas having a majority of the carbon dioxide removed.

System 10 preferably includes one or more pH sensors which preferably measure the pH in flow 16 of alkaline solution and/or the pH of the alkaline solution in reactor 18. In one example, system 10 includes pH sensor 94 located upstream from pump 26 as shown and pH sensor 96 located in reactor 18 as shown. In other examples, system 10 may include any number of pH sensors located at any desired location in system 10.

System 10 preferably includes control subsystem 100, e.g., a programmable logic controller (PLC) or similar type device, preferably coupled to carbon dioxide monitoring subsystem 92, pH adjustment subsystem 30, and one or more pH sensors as shown. Flow control subsystem 100 preferably adjusts the flow rate of flow 36 of concentrated alkaline solution into flow 16 and/or reactor 18 based on the measured carbon dioxide concentration to maintain the pH of the alkaline solution at a predetermined pH range to induce the transfer of the carbon dioxide into a carbonic acid solution and the subsequent conversion of the carbonic acid solution into a solution having metal carbonate therein, as discussed above.

System 10 preferably includes evaporator subsystem 46 coupled to output 24 as shown which evaporates liquid, e.g., water or a similar type of liquid, from flow 28 of solution having metal carbonate therein. Evaporator subsystem 46 preferably outputs metal carbonate slurry or solid 48 and flow 88 of a gas, e.g., water vapor. Metal carbonate slurry or solid 48 therein may be useful in the paper industries, mining, smelting, glass manufacturing including, inter alia, beverage containers and the like, production of lithium carbonate for lithium ion batteries, and the like.

In one example, venturi eductor 14 preferably generates microbubbles and turbulence in flow 16 and reactor 18 which induce the transfer of the carbon dioxide into the carbonic acid solution in reactor 18. Microbubbles have substantial surface area (per unit volume) for the transfer (flux) of CO₂ across the liquid film, e.g., the gas-liquid interface. Microbubbles provide a rapid flux of CO₂ from the gas bubbles into the alkaline solution in reactor 18 and/or flow 16. Turbulence/agitation/mixing reduces the thickness of the laminar liquid layer where molecular diffusion predominates. Molecular diffusion happens much more slowly than dispersion. Dispersion is induced by turbulence. Therefore, turbulence speeds up the flux of gas-phase CO₂ across the gas-liquid interface. The concentration gradient across the gas-liquid interface is also known as the driving force. The larger the concentration gradient, i.e., the difference between CO₂ concentrations on either side of the interface, the faster the CO₂ transfer into the liquid.

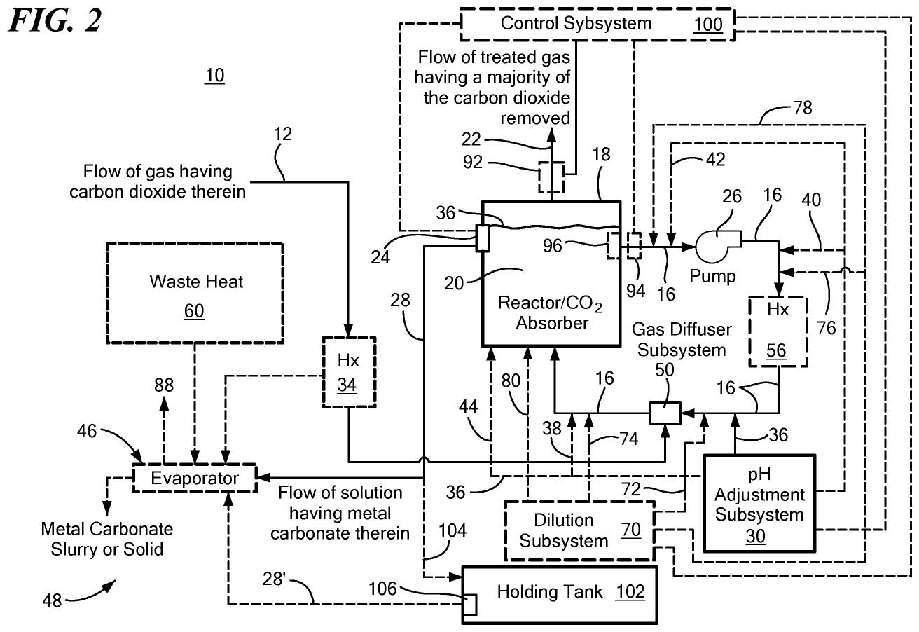

In one design, system 10 may include gas diffuser subsystem 50, FIG. 2, where like parts have been given like numbers, which preferably generates fine bubbles, microbubbles, or nanobubbles in flow 16 and reactor 18 to enhance the transfer of the carbon dioxide into the carbonic acid solution in reactor 18. In one example, gas diffuser subsystem 50 may be located inside reactor 18.

System 10 may also include heat exchanger subsystem 56 coupled to pump 26 which cools flow 16 to maintain the temperature of the alkaline solution in reactor 18 at a temperature which maintains the alkaline solution under the conditions to induce the conversion of the carbon dioxide into the carbonic acid solution.

In one example, pump 26, FIGS. 1 and 2, may be operated in cavitation to promote the transfer of any unreacted carbon dioxide in flow 16 output from reactor 18 into the carbonic acid solution.

In one design, pump 26 operated in cavitation preferably generates microbubbles, fine bubbles, and or nanobubbles and turbulence to further induce the transfer of the carbon dioxide into the carbonic acid solution in flow 16 and/or reactor 18.

In one example, waste heat 60, e.g., waste heat from at least one of a fossil fuel combustion power plant, a boiler, a furnace, an incinerator, a steam generator, a petroleum refinery, a chemical or petrochemical facility, a gas processing facility, a cement plant, an iron or steel manufacturing facility, a brewery, a bakery, a glass manufacturing facility, or similar type facilities or devices, an exhaust gas stream generated by an internal combustion engine may be input to evaporator subsystem 46 as shown to promote the evaporation of liquid from flow 28 of solution having metal carbonate therein by evaporator subsystem 46. System 10 may also utilize waste heat or steam from heat exchanger subsystem 34 as shown which is preferably input to evaporator subsystem 46 to promote the evaporation of liquid from flow 28 of the metal carbonate solution.

As discussed above with reference to FIGS. 1 and 2, flow 36 of concentrated alkaline solution is approximately equal to flow 28 of the solution having metal carbonate therein. In another example, system 10 may operate in batch mode. In this example, flow 28 of the solution having metal carbonate therein is preferably timed based on the reaction time it takes for volume 20 of the alkaline solution at the predetermined pH range in reactor 18 to become supersaturated with metal carbonate. For exemplarily purposes only, if it takes about 250 minutes for volume 20 of the alkaline solution in reactor 18 to become supersaturated with metal carbonate, the majority of volume 20 of the alkaline solution in reactor 18 is emptied by directing flow 28 of the solution having metal carbonate therein to holding tank 102, indicated at 104, about every 240 minutes. Reactor 18 is then refilled with the alkaline solution at the predetermined pH range to run another batch. System 10 is not limited to the example discussed above. Other batch reaction times may vary, as known by those skilled in the art.

When system 10 is operated in batch mode as discussed above, evaporator subsystem 46 is preferably coupled to output 106 of holding tank 102 as shown. Flow 28′ of the solution having metal carbonate therein is preferably directed to evaporator subsystem 46 as shown.

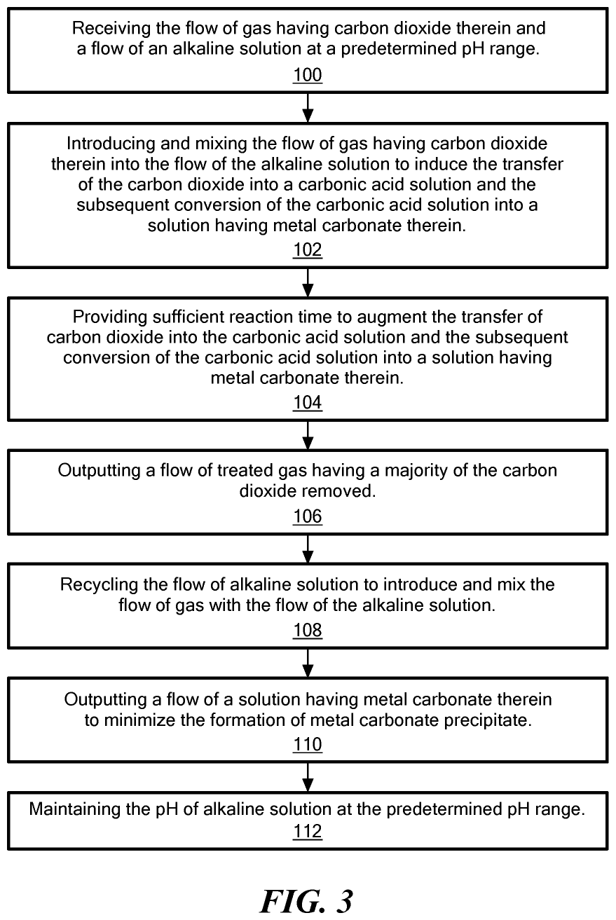

One example of the method for removing carbon dioxide from a flow of gas having carbon dioxide therein includes receiving the flow of gas having carbon dioxide therein and a flow of an alkaline solution at a predetermined pH range, step 100, FIG. 3. The method includes introducing and mixing the flow of gas having carbon dioxide therein into the flow of the alkaline solution to induce the transfer of the carbon dioxide into a carbonic acid solution and the subsequent conversion of the carbonic acid solution into a solution having metal carbonate therein, step 102. The method also includes providing sufficient reaction time to augment the transfer of carbon dioxide into the carbonic acid solution and the subsequent conversion of the carbonic acid solution into a solution having metal carbonate therein, step 104, outputting a flow of treated gas having a majority of the carbon dioxide removed, step 106, recycling the flow of alkaline solution to introduce and mix the flow of gas with the flow of the alkaline solution, step 108, outputting a flow of a solution having metal carbonate therein to minimize the formation of metal carbonate precipitate, step 110, and maintaining the pH of alkaline solution at the predetermined pH range, step 112.

The result is system 10 and the method thereof effectively and efficiently removes carbon dioxide from a flow of gas having carbon dioxide therein. In one example, greater than about 95% of the carbon dioxide is removed from the flow of gas having carbon dioxide therein. In another example, greater than about 99% of the carbon dioxide is removed from the flow of gas having carbon dioxide therein. The flow of gas having carbon dioxide therein may include any gas or vapor source having carbon dioxide therein. The gas or vapor source may include, inter alia, a fossil fuel combustion power plant, a boiler, a furnace, an incinerator, a steam generator, a petroleum refinery, a chemical or petrochemical facility, a gas processing facility, a cement plant, an iron or steel manufacturing facility, a brewery, a bakery, a glass manufacturing facility, or similar type facilities or devices, an exhaust gas stream generated by an internal combustion engine, or a flow of ambient air

System 10 and the method thereof may also utilize waste heat to provide for the evaporation of the flow of the metal carbonate solution. System 10 and the method thereof may also produce a metal carbonate slurry or solid product which may be useful in the paper industries, mining, smelting, glass manufacturing including, inter alia, beverage containers and the like, production of lithium carbonate for lithium ion batteries, and the like.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A system for removing carbon dioxide from flow of gas having carbon dioxide therein, the system comprising:
a venturi eductor configured to receive the flow of gas having carbon dioxide therein and a flow of an alkaline solution at a predetermined pH range, the venturi eductor configured to introduce and mix the flow of gas having carbon dioxide therein into the flow of the alkaline solution to induce the transfer of the carbon dioxide into a carbonic acid solution and the subsequent conversion of the carbonic acid solution into a solution having metal carbonate therein;
a reactor coupled to the venturi eductor, the reactor including a volume of the alkaline solution and configured to provide sufficient reaction time to augment the transfer of carbon dioxide into the carbonic acid solution and the subsequent conversion of the carbonic acid solution into a solution having metal carbonate therein and output a flow of treated gas having a majority of the carbon dioxide removed;
at least one pump coupled to the reactor configured to recycle the flow of alkaline solution from the reactor to the venturi eductor such that the venturi eductor introduces and mixes the flow of gas with the flow of the alkaline solution;
an output coupled to the reactor configured to output a flow of a solution having metal carbonate therein to minimize the formation of metal carbonate precipitate in the reactor; and
a pH adjustment subsystem configured to maintain the pH of alkaline solution at the predetermined pH range.

2. The system of claim 1 including at least one heat exchanger subsystem configured to cool the flow of gas having carbon dioxide therein.

3. The system of claim 1 in which the predetermined pH range is the range about 10 to about 14.

4. The system of claim 1 in which the at least one pump is operated in cavitation to enhance the transfer of unreacted carbon dioxide into the carbonic acid solution.

5. The system of claim 1 including a heat exchanger subsystem coupled to the at least one pump is configured to maintain a temperature of alkaline solution in the reactor at a temperature which induces the transfer of the carbon dioxide into the carbonic acid solution.

6. The system of claim 1 in which the pH adjustment subsystem is configured to introduce a flow of a concentrated alkaline solution into the flow of the alkaline solution and/or the reactor to maintain the pH at the predetermined pH range.

7. The system of claim 1 including a dilution subsystem configured to introduce a flow of water into the flow of the alkaline solution and/or the reactor to minimize precipitation of metal carbonate in the flow of the alkaline solution and/or in the reactor.

8. The system of claim 6 in which the pH adjustment system is configured to minimize formation of metal carbonate precipitate by adjusting the flow rate of the concentrated alkaline solution into the flow of the alkali solution and/or the flow rate of the flow of the concentrated alkaline solution into the reactor.

9. The system of claim 1 including a carbon dioxide monitoring subsystem configured to measure carbon dioxide concentration in the flow of treated gas having a majority of the carbon dioxide removed.

10. The system of claim 9 including one or more pH sensors configured to measure the pH of the flow of alkaline solution and/or the alkaline solution in the reactor.

11. The system of claim 10 including a control subsystem coupled to the carbon dioxide monitoring subsystem, the one or more pH sensors, and the pH adjustment subsystem, the control subsystem configured to adjust the flow rate of the concentrated alkaline solution to maintain the pH of the alkaline solution at the predetermined pH range based on the measured carbon dioxide concentration.

12. The system of claim 1 including a gas diffuser subsystem coupled to the reactor and/or the flow of the alkaline solution configured to generate fine bubbles, microbubbles, and/or nanobubbles to enhance the transfer of the carbon dioxide into the carbonic acid solution.

13. The system of claim 1 including an evaporator subsystem coupled to the output configured to evaporate water from the flow of the solution having metal carbonate therein and output a metal carbonate slurry or a metal carbonate solid and water vapor.

14. The system of claim 13 in which waste heat is input to the evaporator subsystem to promote the evaporation of water from the flow of solution having metal carbonate therein.

15. The system of claim 1 in which greater than about 95% of the carbon dioxide is removed from the flow of gas having carbon dioxide therein.

16. The system of claim 1 in which greater than about 99% of the carbon dioxide is removed from the flow of gas having carbon dioxide therein.

17. The system of claim 1 in which the reactor is operated in batch mode.

18. A method for removing carbon dioxide from a flow of gas having carbon dioxide therein, the method comprising:
receiving the flow of gas having carbon dioxide therein and a flow of an alkaline solution at a predetermined pH range;
introducing and mixing the flow of gas having carbon dioxide therein into the flow of the alkaline solution to induce the transfer of the carbon dioxide into a carbonic acid solution and the subsequent conversion of the carbonic acid solution into a solution having metal carbonate therein;
providing sufficient reaction time to augment the transfer of carbon dioxide into the carbonic acid solution and the subsequent conversion of the carbonic acid solution into a solution having metal carbonate therein;
outputting a flow of treated gas having a majority of the carbon dioxide removed;
recycling the flow of alkaline solution to introduce and mix the flow of gas with the flow of the alkaline solution;
outputting a flow of a solution having metal carbonate therein to minimize the formation of metal carbonate precipitate; and
maintaining the pH of alkaline solution at the predetermined pH range.

19. The method of claim 18 including cooling the flow of gas having carbon dioxide therein.

20. The method of claim 18 in which the predetermined pH range is the range about 10 to about 14.

21. The method of claim 18 including operating at least one pump in cavitation to enhance the transfer of unreacted carbon dioxide into the carbonic acid solution.

22. The method of claim 18 including maintaining the temperature of alkaline solution at a temperature which induces the transfer of the carbon dioxide into the carbonic acid solution.

23. The method of claim 18 including introducing a flow of a concentrated alkaline solution into the flow of the alkaline solution to maintain the pH at the predetermined pH range.

24. The method of claim 18 including introducing a flow of water into the flow of the alkaline solution to minimize precipitation of metal carbonate in the flow of the alkaline solution and/or in the reactor.

25. The method of claim 23 including minimizing formation of metal carbonate precipitate by adjusting the flow rate of the concentrated alkaline solution into the flow of the alkali solution.

26. The method of claim 18 including measuring carbon dioxide concentration in the flow of treated gas having a majority of the carbon dioxide removed.

27. The method of claim 26 including measuring the pH of the flow of alkaline solution and/or the alkaline solution in the reactor.

28. The method of claim 27 including adjusting the flow rate of the concentrated alkaline solution to maintain the pH of the alkaline solution at the predetermined pH range based on the measured pH and the measured carbon dioxide concentration.

29. The method of claim 18 including generating fine bubbles, microbubbles, and/or nanobubbles to enhance the transfer of the carbon dioxide into the carbonic acid solution.

30. The method of claim 18 including evaporating water from the flow of the solution having metal carbonate therein and outputting a metal carbonate slurry or a metal carbonate solid and water vapor.

31. The method of claim 30 in which waste heat is input to promote the evaporation of water from the flow of solution having metal carbonate therein.

32. The method of claim 18 in which greater than about 95% of the carbon dioxide is removed from the flow of gas having carbon dioxide therein.

33. The method of claim 18 in which greater than about 99% of the carbon dioxide is removed from the flow of gas having carbon dioxide therein.

34. The method of claim 18 in which providing sufficient reaction time is performed in batch mode.
